(19) United States
(12) Patent Application Publication
(10) Pub. No.: US 2009/0072939 A1
(43) Pub. Date: Mar. 19, 2009

(54) MAGNET SYSTEM AND MRI APPARATUS

(76) Inventors: Weijun Shen, Florence, SC (US); Fengshun Tan, Florence, SC (US); Guanghui Shen, Wuxi (CN); Yihe Hua, Wuxi (CN); Ye Zhu, Wuxi (CN)

Correspondence Address: Patrick W. Rasche;Armstrong Teasdale LLP, Suite 2600, One Metropolitan Square, St. Louis, MO, 63102, US

(21) Appl. No.: 12/209,652

(22) Filed: Sep. 12, 2008

(30) Foreign Application Priority Data
Sep. 14, 2007 (CN) 200710153682.X

(51) Int. Cl. H01F 7/02

(52) U.S. Cl. 335/306

(57) ABSTRACT

A magnet system having a pair of parallel plate-like permanent magnets in which magnetic poles of reversed polarities are opposed to each other with a space therebetween. The pair of permanent magnets includes main portions magnetized in the same direction as their thickness direction, and peripheral portions magnetized in a direction different from their thickness direction.

### CROSS REFERENCE TO RELATED APPLICATIONS

This application claims the benefit of Chinese Patent Application No. 200710153682.X filed Sep. 14, 2007, which is hereby incorporated by reference in its entirety.

### BACKGROUND OF THE INVENTION

The subject matter disclosed herein relates to a magnet system and an MRI (Magnetic Resonance Imaging) apparatus and, more specifically, to a magnet system using permanent magnets and an MRI apparatus that reconstructs an image on the basis of magnetic resonance signals collected through the magnet system.

The MRI apparatus reconstructs an image on the basis of magnetic resonance signals collected through the magnet system. There is one type of the above magnet system using permanent magnets. Such a magnet system uses a pair of permanent magnets in which magnetic poles of reversed polarities are opposed to each other with a space therebetween (See, for instance, Japanese Unexamined Patent Publication No. 2002-369807).

FIG. 10 is a vertical cross-sectional view showing a schematic configuration of a magnet system of this type. FIG. 10 shows a cross section 50 along a median line of the magnet system 10. As shown in FIG. 10, the magnet system 10 is configured such that a pair of disc-like magnet blocks 11a and 11b are supported in parallel by a C-shaped yoke 30 wherein magnetic poles of reversed polarities are opposed to each other with an imaging space therebetween.

The magnet blocks 11a and 11b are magnetized in their thickness direction, and pole pieces 13a and 13b are provided on the opposing pole faces, respectively. Close to the pole pieces 13a and 13b, a pair of gradient coils and RF coils (radio frequency coils) are provided, respectively (not shown).

As shown in FIG. 11, the pole pieces 13a and 13b are configured such that rings 17a and 17b are provided along peripheries of discs 15a and 15b, and surfaces of the discs 15a and 15b on the inner side of the rings 17a and 17b are covered with laminated tiles 19a and 19b.

Soft iron etc. are used as a material for the discs 15a and 15b and rings 17a and 17b, and a laminated body of a silicon steel plate etc. are used as a material for the laminated tiles 19a and 19b. Layers of the laminated body are parallel to the direction of a magnetic field. With use of such pole pieces 13a and 13b, magnetic fluxes can be distributed evenly in the imaging space and eddy currents can be reduced when driving the gradient coils.

On the other hand, the pole pieces interfere with the magnetic fields of the permanent magnets. Therefore, when it is necessary to avoid it, the pole pieces are removed, and layers of soft magnetic material are provided on the magnetic poles on the side opposite to the side where the magnetic poles are opposed to each other (See, for instance, US Patent Unexamined Publication No. 2002/0175792).

When the layers of the soft magnetic material are provided in the magnetic poles on the opposite side, the magnetic fluxes are distributed evenly in the imaging space by providing a plurality of level differences on surfaces of the magnetic poles on the side where the permanent magnets are opposed to each other (See, for instance, US Patent Unexamined Publication No. 2005/0068138).

When the construction of the magnet system 10 is as shown in FIG. 12 in the second quadrant B of the cross section 50, magnetic lines of force are distributed as shown in FIG. 13. The distribution of the magnetic lines of force is found by the finite element method. As shown in the upper right portion of FIG. 13, quite a few of the magnetic lines of force generated by the magnet blocks leak into the yoke, without being directed to the imaging space. These leakage magnetic lines of force worsen use efficiency of magnetic energy.

As for the magnet system for MRI apparatuses, even if the use efficiency of magnetic energy is low, it is desirable for a magnetic field intensity to be as high as possible. Therefore, a highly efficient magnet of alloy containing a rare earth element is used for the magnet block. However, the highly efficient magnet is expensive. Therefore, as for the magnetic field intensity of the magnet system, about 0.35 T is a limit in terms of cost.

In order to raise the magnetic field intensity without increasing the cost, it is necessary to increase the use efficiency of the magnetic energy of the magnet system. Up to now, however, there has been no such technology that makes it possible.

### BRIEF DESCRIPTION OF THE INVENTION

It is desirable that the problems described previously are solved.

An invention according to a first aspect is a magnet system having a pair of parallel plate-like permanent magnets in which magnetic poles of reversed polarities are opposed to each other with a space therebetween, wherein the pair of permanent magnets include main portions magnetized in the same direction as their thickness direction and peripheral portions magnetized in a direction different from their thickness direction.

An invention according to a second aspect is a magnet system as described in the first aspect, wherein the peripheral portions are border portions of the magnetic poles on the side where the pair of permanent magnets are opposed to each other.

An invention according to a third aspect is a magnet system as described in the first aspect, wherein the peripheral portions are side circumference portions of the pair of permanent magnets.

An invention according to a fourth aspect is a magnet system as described in the first aspect, wherein the peripheral portions are border portions of the magnetic poles on the side where the pair of permanent magnets are opposed to each other and the side circumference portions of the pair of permanent magnets.

An invention according to a fifth aspect is a magnet system as described in the second or fourth aspect, wherein an angle of inclination of the magnetizing direction in the border portion is 90 degrees to the thickness direction.

An invention according to a sixth aspect is a magnet system as described in the fifth aspect, wherein the border portion includes a ring-like magnet.

An invention according to a seventh aspect is a magnet system as described in the third or fourth aspect, wherein an angle of inclination of the magnetizing direction in the side circumference portion is between 20 degrees and 50 degrees to the thickness direction.

An invention according to an eighth aspect is a magnet system as described in the seventh aspect, wherein the angle of inclination is 25 degrees.

An invention according to a ninth aspect is a magnet system as described in the eighth aspect, wherein the side circumference portion includes a ring-like magnet.

An invention according to a tenth aspect is a magnet system as described in the first aspect, wherein the pair of permanent magnets respectively have layers of soft magnetic material in magnetic poles on the side opposite to the side where the permanent magnets are opposed to each other.

An invention according to an eleventh aspect is an MRI apparatus which reconstructs an image on the basis of magnetic resonance signals collected through a magnet system having a pair of parallel plate-like permanent magnets in which magnetic poles of reversed polarities are opposed to each other with a space therebetween, gradient magnetic coils, and RF coils, wherein the pair of permanent magnets include main portions magnetized in the same direction as their thickness direction and peripheral portions magnetized in a direction different from their thickness direction.

An invention according to a twelfth aspect is an MRI apparatus as described in the eleventh aspect, wherein the peripheral portions are border portions of the magnetic poles on the side where the pair of permanent magnets are opposed to each other.

An invention according to a thirteenth aspect is an MRI apparatus as described in the eleventh aspect, wherein the peripheral portions are side circumference portions of the pair of permanent magnets.

An invention according to a fourteenth aspect is an MRI apparatus as described in the eleventh aspect, wherein the peripheral portions are border portions of the magnetic poles on the side where the pair of permanent magnets are opposed to each other and the side circumference portions of the pair of permanent magnets.

An invention according to a fifteenth aspect is an MRI apparatus as described in the twelfth or fourteenth aspect, wherein the angle of inclination of the magnetizing direction in the border portion is 90 degrees to the thickness direction.

An invention according to a sixteenth aspect is an MRI apparatus as described in the fifteenth aspect, wherein the border portion includes a ring-like magnet.

An invention according to a seventeenth aspect is an MRI apparatus as described in the thirteenth or fourteenth aspect, wherein the angle of inclination of the magnetizing direction in the side circumference portion is between 20 degrees and 50 degrees to the thickness direction.

An invention according to an eighteenth aspect is an MRI apparatus as described in the seventeenth aspect, wherein the angle of inclination is 25 degrees.

An invention according to a nineteenth aspect is an MRI apparatus as described in the eighteenth aspect, wherein the side circumference portion includes a ring-like magnet.

An invention according to a twentieth aspect is an MRI apparatus as described in the eleventh aspect, wherein the pair of permanent magnets respectively have layers of soft magnetic material in the magnetic poles on the side opposite to the side where the permanent magnets are opposed to each other.

According to the invention of the first aspect, the magnet system has the pair of parallel plate-like permanent magnets in which magnetic poles of reversed polarities are opposed to each other with a space therebetween. Further, the pair of permanent magnets include the main portions magnetized in the same direction as their thickness direction and the peripheral portions magnetized in a direction different from their thickness direction. Therefore, a magnet system with excellent use efficiency of magnetic energy of the permanent magnets can be realized.

According to the invention of the eleventh aspect, the MRI apparatus reconstructs an image on the basis of magnetic resonance signals collected through the magnet system having the pair of parallel plate-like permanent magnets in which magnetic poles of reversed polarities are opposed with a space therebetween, gradient magnetic coils, and RF coils. Further, the pair of permanent magnets include the main portions magnetized in the same direction as their thickness direction and the peripheral portions magnetized in the direction different from their thickness direction. Therefore, an MRI apparatus having a magnet system with excellent use efficiency of magnet energy of the permanent magnets can be realized.

According to the invention of the second or twelfth aspect, the peripheral portions are the border portions of the magnetic poles on the side where the pair of permanent magnets are opposed to each other. Therefore, the effect of the magnetization in the different direction can be increased.

According to the invention of the third or thirteenth aspect, the peripheral portion is the side circumference portions of the pair of permanent magnets. Therefore, the effect of the magnetization in the different direction can be increased.

According to the invention of the fourth or fourteenth aspect, the peripheral portions are the border portions of the magnetic poles on the side where the pair of permanent magnets are opposed to each other and the side circumference portions of the pair of permanent magnets. Therefore, the effect of the magnetization in the different direction can be increased.

According to the invention of the fifth or fifteenth aspect, the angle of inclination of the magnetizing direction in the border portion is 90 degrees to the thickness direction. Therefore, the effect of magnetization in the different direction can be optimized.

According to the invention of the sixth or sixteenth aspect, the border portion includes a ring-like magnet. Therefore, the magnetization of the border portion in the different direction can easily be realized.

According to the invention of the seventh or seventeenth aspect, the angle of inclination of the magnetizing direction in the side circumference portion is between 20 degrees and 50 degrees to the thickness direction. Therefore, the effect of magnetization in the different direction can be optimized.

According to the invention of the eighth or eighteenth aspect, the angle of inclination is 25 degrees. Therefore, the effect of magnetization in the different direction can be optimized.

According to the invention of the ninth or nineteenth aspect, the side circumference portion includes a ring-like magnet. Therefore, the magnetization of the side circumference portion in the different direction can easily be realized.

According to the invention of the tenth or twentieth aspect, the pair of permanent magnets respectively have layers of soft magnetic material in magnetic poles on the side opposite to the side where the permanent magnets are opposed to each other. Therefore, residual magnetism in the gradient magnet field can be reduced.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram of an exemplary MRI apparatus.

FIG. 2 is a perspective view of an exemplary magnet system that may be used with the MRI apparatus shown in FIG. 1.

FIGS. 3(a) and 3(b) show a construction in a first quadrant of the magnet system shown in FIG. 2.

FIG. 4 is a cross-sectional view of the magnet system shown in FIG. 2.

FIG. 5 shows the distribution of magnetic lines of force of the magnet system shown in FIG. 2.

FIGS. 6(a) and 6(b) show a construction in the first guardant of a second exemplary magnet system that may be used with the MRI apparatus shown in FIG. 1.

FIG. 7 is a cross-sectional view of a third exemplary magnet system that may be used with the MRI apparatus shown in FIG. 1.

FIGS. 8(a) and 8(b) show, in comparison with a conventional system, the magnet system.

FIG. 9 shows actually measured results of the intensity of the gradient magnetic field.

FIG. 10 is a cross-sectional view of a conventional magnet system.

FIG. 11 is a perspective view of a pole piece of the conventional magnet system.

FIG. 12 shows a construction in a first quadrant of the conventional magnet system.

FIG. 13 shows the distribution of magnetic lines of force of the conventional magnetic system.

### DETAILED DESCRIPTION OF THE INVENTION

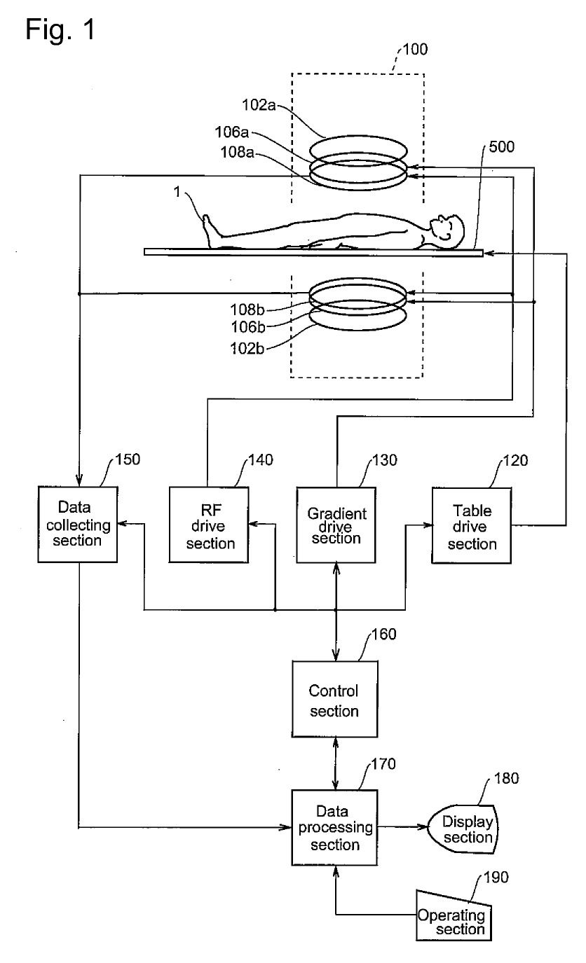

The best mode for carrying out the invention will be described in detail below with reference to drawings. Also, the invention is not limited to the mode for carrying out the invention. FIG. 1 is a block diagram of an MRI apparatus. This apparatus is an example of the best mode of implementing the invention. The configuration of this apparatus represents an apparatus, which is an example of the best mode of implementing the invention.

As shown in FIG. 1, the apparatus has a magnet system 100. The magnet system 100 has main magnetic field sections 102a and 102b, gradient coil sections 106a and 106b, and RF coil sections 108a and 108b.

The main magnetic field sections 102a and 102b, the gradient coil sections 106a and 106b, and the RF coil sections 108a and 108b are all paired ones, one opposite the other with a space between them. Also, they are substantially in the disc-like shapes and disposed coaxially.

A subject 1, mounted on a table 500, is brought into and out of an imaging space of the magnet system 100. The table 500 is driven by a table drive section 120. The main magnetic field sections 102a and 102b form a magnetostatic field in the imaging space of the magnet system 100. The direction of the magnetostatic field is substantially orthogonal to that of the bodily axis of the subject 1. This forms a so-called vertical magnetic field. The main magnetic field sections 102a and 102b are comprised of hard magnetic material or permanent magnets. The main magnetic field sections 102a and 102b will be described later.

The gradient coil sections 106a and 106b create three gradient magnetic fields for giving gradients to respective static magnetic field intensities in the directions of three mutually normal axes, i.e. a slice axis, a phase axis, and a frequency axis. The gradient coil sections 106a and 106b have three lines of gradient coils (not shown), each matching one or another of the three gradient magnetic fields.

The RF coil sections 108a and 108b transmit to the static magnetic field space an RF pulse (radio frequency pulse) for exciting spins within the body of the subject 1. The RF coil sections 108a and 108b also receive magnetic resonance signals generated by the excited spins. The RF coil sections 108a and 108b may either be a single coil for both transmission and reception or include separate coils, one for transmission and the other for reception.

A gradient drive section 130 is connected to the gradient coil sections 106a and 106b. The gradient drive section 130 provides a drive signal to the gradient coil sections 106a and 106b to cause a gradient magnetic field to be generated. The gradient drive section 130 has three lines of drive circuits (not shown), respectively matching the three lines of gradient coils in the gradient coil sections 106a and 106b.

An RF drive section 140 is connected to the RF coil sections 108a and 108b. The RF drive section 140 provides a drive signal to the RF coil sections 108a and 109b to transmit an RE pulse, and excites spins within the body of the subject 1.

A data collecting section 150 is connected to the RF coil sections 108a and 108b. The data collecting section 150 takes in receive signals received by the RF coil sections 108a and 108b by sampling, and collects them as digital data.

A control section 160 is connected to the table drive section 120, the gradient drive section 130, the RF drive section 140, and the data collecting section 150. The control section 160 controls the units from the table drive section 120 through the data collecting section 150 to carry out imaging.

The control section 160 is configured by using, for instance, a computer or the like. The control section 160 has a memory. The memory stores programs for the control section 160 and various data. The functions of the control section 160 are realized by the execution of programs stored in the memory by the computer.

The output side of the data collecting section 150 is connected to a data processing section 170. Data collected by the data collecting section 150 are inputted to the data processing section 170. The data processing section 170 is configured by using, for instance, a computer or the like. The data processing section 170 has a memory. The memory sores programs for the data processing section 170 and various data.

The data processing section 170 is connected to the control section 160. The data processing section 170 is positioned superior to, and exercises general control over, the control section 160. The functions of this apparatus are realized by the execution of programs, stored in the memory, by the data processing section 170.

The data processing section 170 stores data, collected by the data collecting section 150, into the memory. A data space is formed within the memory. This data space constitutes a Fourier space. The Fourier space will also be referred to as the k-space hereafter. The data processing section 170 reconstructs an image of the subject 1 by subjecting data in the k-space to an inverse Fourier transform.

A display section 180 and an operation section 190 are connected to the data processing section 170. The display section 180 is configured of a graphic display or the like. The operation section 190 includes a keyboard or the like, provided with a pointing device.

The display section 180 displays reconstructed images and various information outputted from the data processing section 170. The operation section 190 is operated by the user to input various commands, information and so forth to the data processing section 170. The user can interactively operates this apparatus through the display section 180 and the operation section 190.

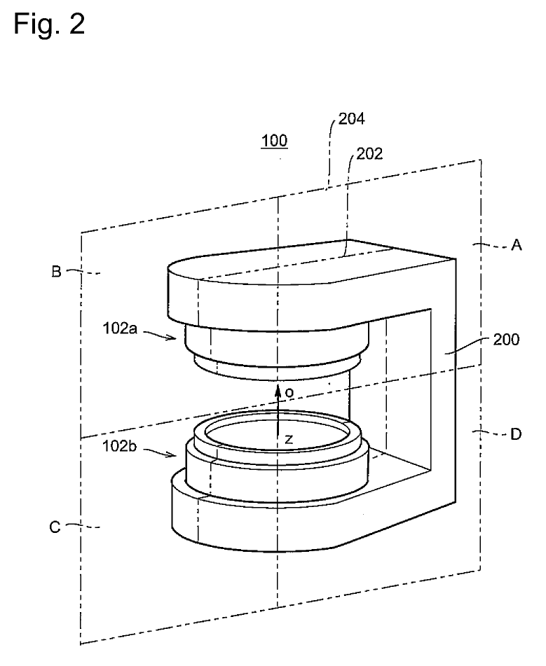

Now, the magnet system 100 will be described. FIG. 2 is a perspective view showing an example of the magnet system 100. As shown in FIG. 2, the magnet system 100 is configured such that a pair of main magnetic field sections 102a and 102b are supported by a yoke 200.

The main magnetic field sections 102a and 102b have substantially disc-like or short column-like external looks. Further, the outline of the outer circumference of the main magnetic field sections 102a and 102b is not limited to a circle, and it may be of any appropriate shape such as an ellipse or a polygon.

The yoke 200 serves as a support mechanism for the pair of main magnetic field sections 102a and 102b and a return magnetic path. For instance, the yoke 200 is made of soft magnetic materials such as soft iron, and is formed substantially in the shape of C. Further, the yoke 200 is not necessarily C-shaped, and any appropriate shape may be applied.

The C-shaped yoke 200 supports the main magnetic field sections 102a and 102b in parallel and coaxially such that their magnetic poles of reversed polarities are opposed to each other with a predetermined space therebetween by a pair of horizontal legs extending from both ends of the vertical leg.

A vertical magnetic field is formed in the imaging space between the both magnetic poles. Hereafter, the direction of the vertical magnetic field will be referred to as z-direction. Also, the side where the magnetic poles of the main magnetic field sections 102a and 102b are opposed to each other are referred to as space sides and the other sides are referred to as yoke sides.

On the space sides of the main magnetic field sections 102a and 102b, there are provided the gradient coil sections 106a and 106b as well as RF coil sections 108a and 108b (not shown) of FIG. 1 close to pole faces.

With respect to the magnet system 100, a cross section 204 along its median line 202 is defined. Further, the cross section 204 is divided into four quadrants A, B, C, and D with the center O of the imaging space as a point of origin. These four quadrants A, B, C, and D are a first quadrant, a second quadrant, a third quadrant, and a fourth quadrant, respectively.

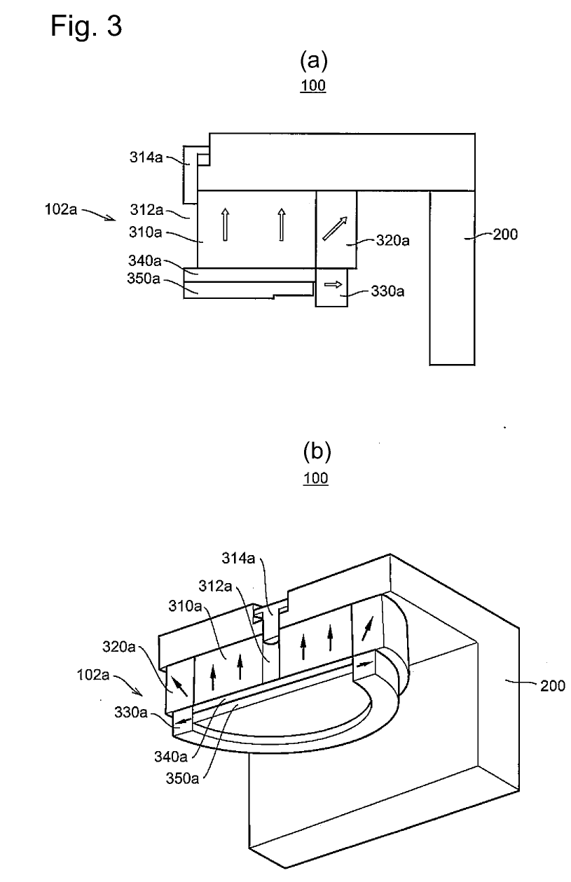

FIGS. 3(a) and 3(b) show an example of the detailed configuration of the magnet system 100. FIG. 3(a) is a cross-sectional view of the magnet system 100 in the first quadrant A, and FIG. 3(b) is a perspective view of a three-dimensional construction of the magnet system 100 in the first quadrant A.

As shown in FIGS. 3(a) and 3(b), the main magnetic field section 102a includes three coaxial magnet rings 310a, 320a, and 330a, and two layers of pole pieces 340a and 350a.

The magnet rings 310a, 320a, and 330a are all comprised of hard magnetic material, or permanent magnets. On the contrary, the pole pieces 340a and 350a are of soft magnetic material and include, for instance, a soft iron plate and a laminated tile plate, etc., respectively. The laminated tile plate is formed, for instance, by laminating silicon steel plates etc. in parallel in the magnetizing direction. Hereafter, the pole piece 340a may be referred to as a soft iron plate, and the pole piece 350a may be referred to as a laminated tile plate.

As shown by a plurality of arrows, the magnet ring 310a is magnetized in the same direction as its thickness direction. From the side of the yoke 200, a magnetic material 314a for adjustment is inserted into a hollow portion 312a formed in the center of the magnet ring 310a.

The magnet ring 310a makes up most of the volume of the main magnetic field section 102a, and serves as a principal part of the main magnetic field section 102a. The magnet ring 310a is an example of the principal part of the permanent magnet in the invention.

The magnet ring 320a is provided such that it surrounds the side circumference of the magnet ring 310a. As shown by arrows, the magnet ring 320a is magnetized in a direction different from its thickness direction. The magnet ring 320a is an example of the peripheral portion of the permanent magnet in the invention. The magnet ring 320a is also an example of the side circumference portion of the permanent magnet in the invention.

Magnetizing directions of the magnet ring 320a incline with respect to the thickness direction in the cross section. The directions of inclination are shown by tips of arrows that incline outward on the yoke side and inward on the space side. The angle of inclination between 20 degrees and 50 degrees is appropriate, and the optimum angle is 25 degrees.

The magnet ring 330a is provided on the space side of the magnet ring 320a. An outside diameter and an inside diameter of the magnet ring 330a are substantially equal to an outside diameter of the magnet ring 320a and an outside diameter of the magnet ring 310a, respectively. The magnet ring 330a is an example of the peripheral portion of the permanent magnet in the invention. The magnet ring 330a is also an example of the border portion of the magnetic pole of the permanent magnet in the invention.

As shown by arrows, the magnet ring 330a is magnetized in directions different from its thickness direction. The magnetizing directions of the magnet ring 320a incline at an angle of 90 degrees to the thickness direction in the cross section. The direction of inclination is the same as the directions of inclination of magnetization in the magnet ring 320a, and is equivalent to the angle of inclination when it is 90 degrees. That is, the magnet ring 330a is magnetized radially.

Inside the magnet ring 330a, two layers of the pole pieces 340a and 350a are provided so as to cover the pole face on the space side of the magnet ring 310a. As for the two layers of the pole pieces 340a and 350a, the soft iron plate 340a serves as an internal layer and the laminated tile plate 350a serves as an external layer.

Described above is the construction of the magnet system 100 in the first quadrant A. Except for the vertical leg of the yoke 200, the construction of the magnet system 100 in the second quadrant B is a mirror image of the construction in the first quadrant A.

The constructions of the magnet system 100 in the third quadrant C and the fourth quadrant D are mirror images of the constructions in the second quadrant and the first quadrant, respectively. However, the polarity of the magnetization of the permanent magnet is opposite to the one in the mirror image.

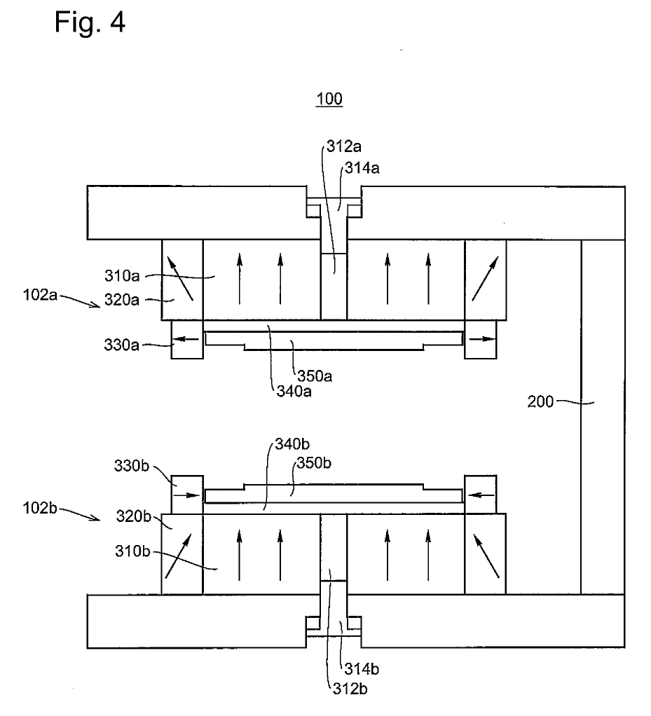

FIG. 4 shows the construction of the magnet system 100 through the four quadrants. As shown in FIG. 4, the main magnetic field sections 102a and 102b have the same construction but reversed polarities of magnetization.

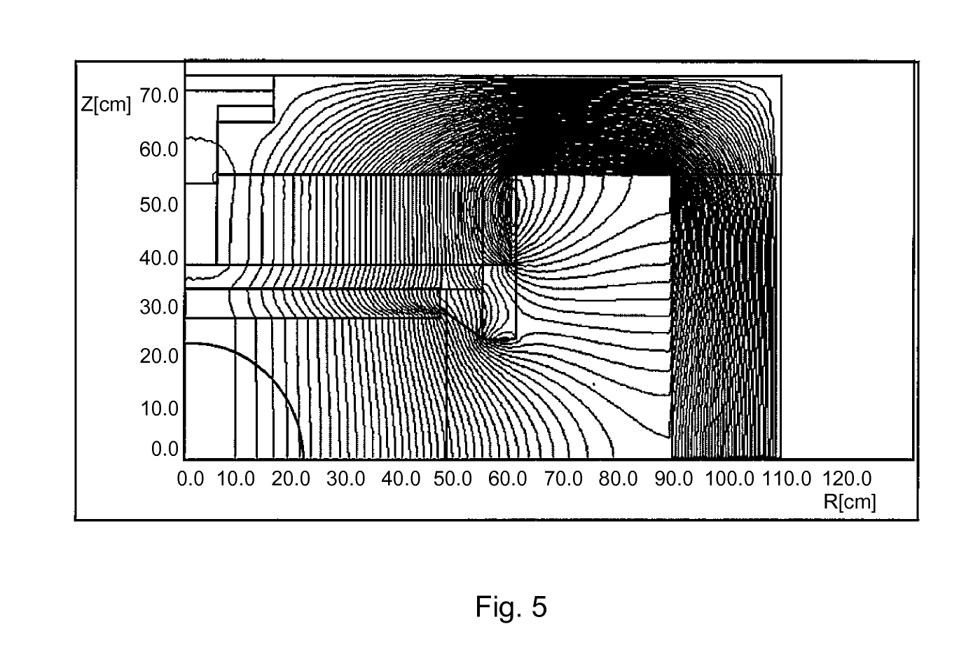

The distribution of magnetic lines of force in the magnet system 100 is shown in FIG. 5 with respect to the first quadrant. The distribution of the magnetic lines of force is found by the finite element method. As shown in FIG. 5, in the magnet system 100, magnetic lines of force leaking to the yoke decrease in number and magnetic lines of force toward the imaging space increase. That is, ineffective magnetic lines of forces decrease in number, and effective magnetic lines of force increase. The decrease in ineffective magnetic lines of force and the increase in effective magnetic lines of force are clearer if compared with the distribution of the magnetic lines of force in the conventional magnet system shown in FIG. 13.

Thus, use efficiency of the magnet energy in the magnet system 100 is increased. Accordingly, at substantially the same cost as a conventional system such as the magnet system of 0.35T, a magnet system of 0.5T whose magnetic field intensity is higher, for instance, can easily be realized. Alternatively, a magnet system having substantially the same magnetic field intensity as the conventional system can be realized at a lower cost.

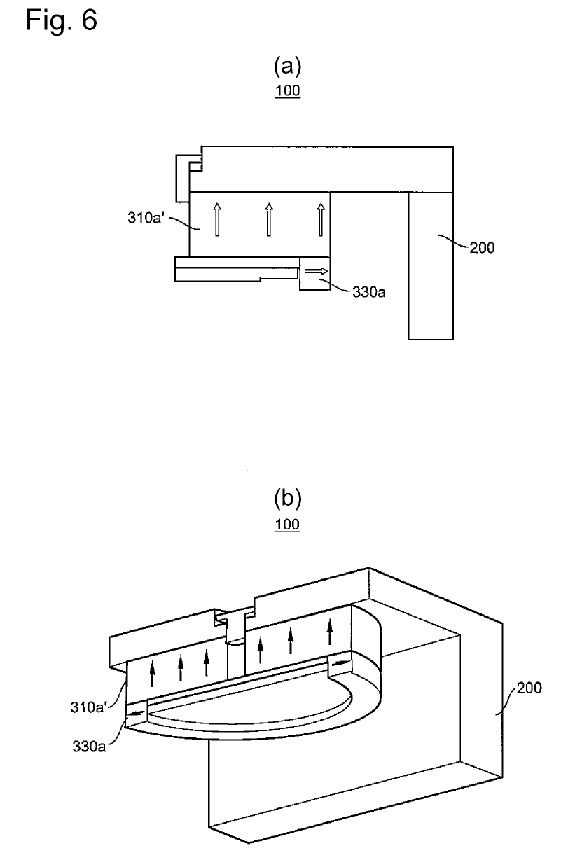

Another example of the construction of the magnet system 100 is shown in FIGS. 6(a) and 6(b). FIG. 6(a) is a cross-sectional view in the first quadrant A, and FIG. 6(b) is a perspective view of a three-dimensional construction in the first quadrant A. The magnet system 100 in FIGS. 6(a) and 6(b) differs from the one in FIG. 3 in that the portions occupied by the two magnet rings 310a and 320a in FIG. 3 are replaced with a single magnet ring 310a′. Even with such a construction, a magnet system having sufficient use efficiency of magnetic energy can be obtained according to the effect of the magnet ring 330a magnetized radially.

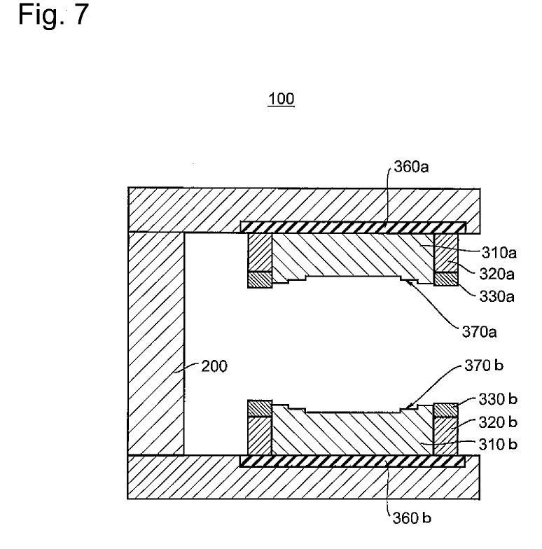

FIG. 7 is a cross-sectional view along a median line showing still another example of the construction of the magnet system 100. The first difference between the one shown in FIG. 4 and the construction of the magnet system 100 of FIG. 7 is that pole pieces 350a and 350b are eliminated from the magnetic poles on the space side and that the layers 360a and 360b of soft magnetic material are provided in the magnetic poles on the yoke side. As the layers 360a and 360b of soft magnetic material, for instance, laminated tile plates etc. may be used. The second difference is that a plurality of level differences 370a and 370b are provided on the pole faces on the space side of the magnetic rings 310a and 310b.

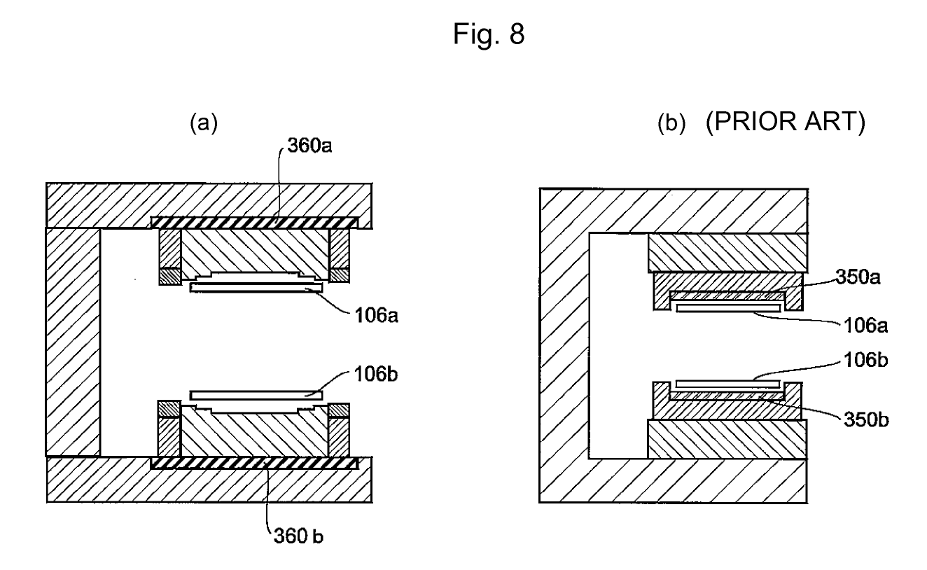

The construction of magnet system 100 shown in FIG. 7 facilitates eliminating the interference of the pole pieces and an even distribution of the magnetic fluxes. Moreover, the merit of the magnetic energy use efficiency of the magnet rings 320a, 330a, 320b, and 330b is maintained as it is. The layers 360a and 360b of the soft magnetic material are moved to the magnetic poles on the yoke side. Therefore, as shown in FIG. 8(a), the layers 360a and 360b of the soft magnetic material are located away from the gradient coil sections 106a and 106b. This distance is much greater than the distance when the laminated tile plates 350a and 350b are provided in the magnetic poles on the space side as in the conventional example of FIG. 8(b). For this reason, the influence of the gradient magnetic field generated by the gradient coil sections 106a and 106b is sharply reduced as compared to the conventional case.

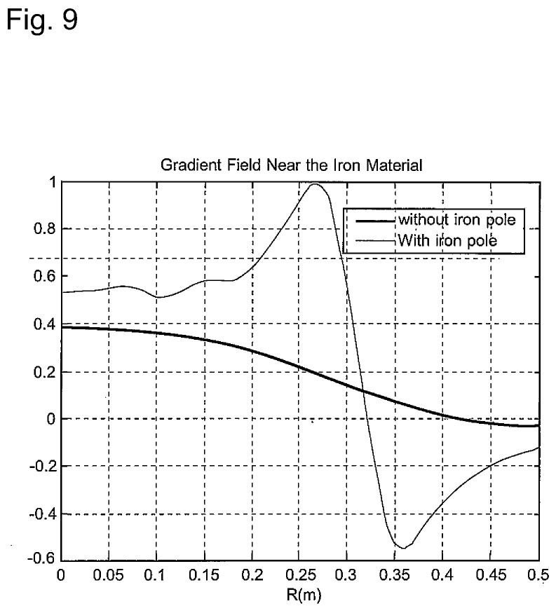

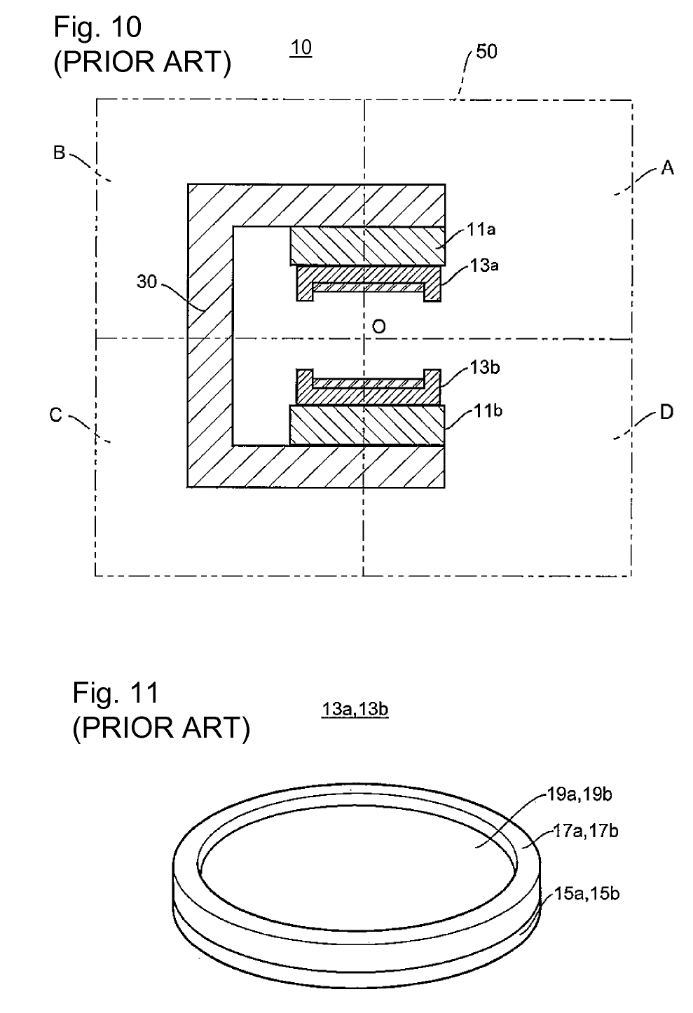

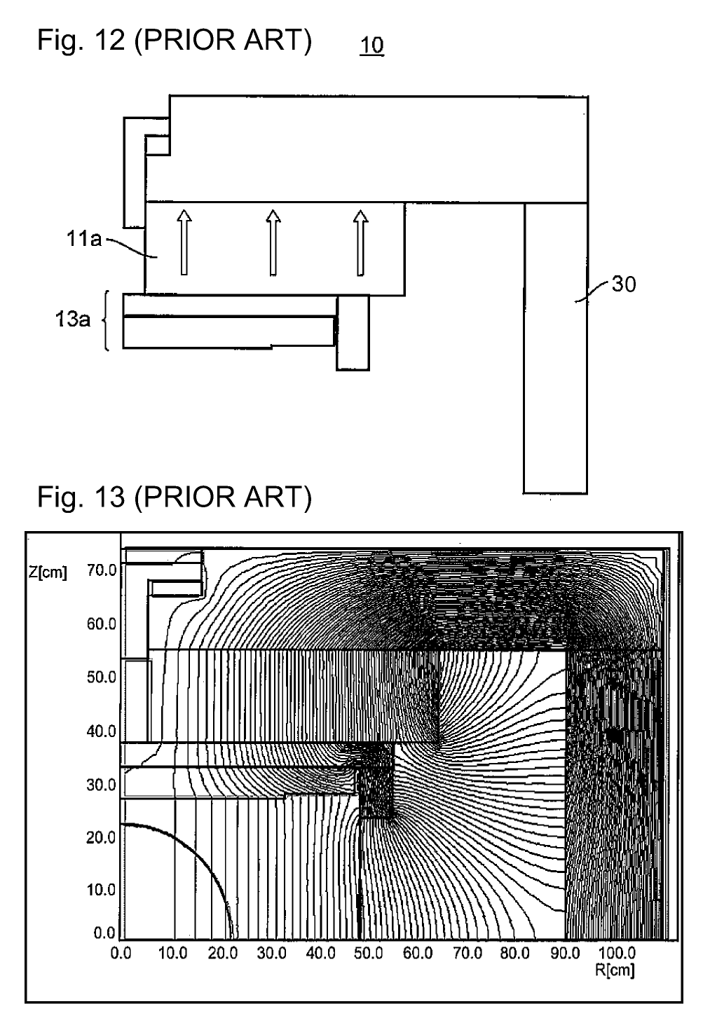

FIG. 9 is a graph showing actually measured results in the gradient magnetic field. The vertical and horizontal axes of the graph respectively show the normalized magnetic field intensity and the measuring positions in the horizontal direction. The thick line in the graph shows actual measured values at the positions of the layers 360a and 360b of the soft magnetic material and the thin line in the graph shows actual measured values at the positions of the laminated tile plates 350a and 350b.

As shown by these graphs, the effect of the gradient magnetic field to the layers 360a and 360b of the soft magnetic material is considerably smaller than the effect to the laminated tile plates 350a and 350b. Accordingly, residual magnetism in the layers 360a and 360b of the soft magnetic material is much smaller than residual magnetism in the laminated tile plates 350a and 350b.

Many widely different embodiments of the invention may be configured without departing from the spirit and the scope of the present invention. It should be understood that the present invention is not limited to the specific embodiments described in the specification, except as defined in the appended claim.

1. A magnet system comprising:
a pair of parallel plate-like permanent magnets in which magnetic poles of reversed polarities are opposed to each other with a space therebetween, each of said pair of permanent magnets comprising:
a main portion magnetized in a same direction as a thickness direction; and
a peripheral portion magnetized in a direction different from the thickness direction.

2. A magnet system according to claim 1, wherein each said peripheral portion comprises a border portion of the magnetic pole on a side where said pair of permanent magnets are opposed to each other.

3. A magnet system according to claim 1, wherein each said peripheral portion comprises a side circumference portion of said pair of permanent magnets.

4. A magnet system according to claim 1, wherein each said peripheral portion comprises a border portion of the magnetic poles on a side where said pair of permanent magnets are opposed to each other and a side circumference portion of each of said pair of permanent magnets.

5. A magnet system according to claim 2, wherein an angle of inclination of the magnetizing direction in each said border portion is 90 degrees to the thickness direction.

6. A magnet system according to claim 5, wherein each said border portion comprises a ring-like magnet.

7. A magnet system according to claim 3, wherein an angle of inclination of the magnetizing direction in each said side circumference portion is between 20 degrees and 50 degrees to the thickness direction.

8. A magnet system according to claim 7, wherein said angle of inclination is 25 degrees.

9. A magnet system according to claim 8, wherein each said side circumference portion comprises a ring-like magnet.

10. A magnet system according to claim 1, wherein each of said pair of permanent magnets comprises layers of soft magnetic material in magnetic poles on a first side opposite to a second side where said pair of permanent magnets are opposed to each other.

11. An MRI apparatus configured to reconstruct an image based on magnetic resonance signals collected through a magnet system having a pair of parallel plate-like permanent magnets in which magnetic poles of reversed polarities are opposed to each other with a space therebetween, gradient magnetic coils, and RF coils, said magnet system comprising:
a pair of parallel plate-like permanent magnets in which magnetic poles of reversed polarities are opposed to each other with a space therebetween, each of said pair of permanent magnets comprising:
a main portion magnetized in the a same direction as a thickness direction; and
a peripheral portion magnetized in a direction different from the thickness direction.

12. An MRI apparatus according to claim 11, wherein each said peripheral portion comprises a border portion of the magnetic poles on a side where said pair of permanent magnets are opposed to each other.

13. An MRI apparatus according to claim 11, wherein each said peripheral portion comprises a side circumference portion of said pair of permanent magnets.

14. An MRI apparatus according to claim 11, wherein each said peripheral portion comprises a border of the magnetic poles on a side where said pair of permanent magnets are opposed to each other and a side circumference portion of said pair of permanent magnets.

15. An MRI apparatus according to claim 12, wherein an angle of inclination of the magnetizing direction in each said border portion is 90 degrees to the thickness direction.

16. An MRI apparatus according to claim 15, wherein each said border portion comprises a ring-like magnet.

17. An MRI apparatus according to claim 13, wherein an angle of inclination of the magnetizing direction in each said side circumference portion is between 20 degrees and 50 degrees to the thickness direction.

18. An MRI apparatus according to claim 17, wherein said angle of inclination is 25 degrees.

19. An MRI apparatus according to claim 18, wherein each said side circumference portion comprises a ring-like magnet.

20. An MRI apparatus according to claim 11, wherein each of said pair of permanent magnets comprises layers of soft magnetic material in the magnetic poles on a first side opposite to a second side where said pair of permanent magnets are opposed to each other.
